(19) United States
(12) Patent Application Publication
(10) Pub. No.: US 2023/0391956 A1
(43) Pub. Date: Dec. 7, 2023

(54) SILYL ETHER ISOHEXIDE-BASED ORGANIC-INORGANIC COMPOUND, METHOD FOR PREPARING THE SAME, AND CURABLE COMPOSITION CONTAINING THE SAME

(71) Applicant: ELECTRONICS AND TELECOMMUNICATIONS RESEARCH INSTITUTE, Daejeon (KR)

(72) Inventors: GWANG-MUN CHOI, Daejeon (KR); Yong Sung EOM, Daejeon (KR); Jiho JOO, Daejeon (KR); KWANG-SEONG CHOI, Daejeon (KR); Seok-Hwan MOON, Daejeon (KR); Jin Hyuk OH, Daejeon (KR); Ho-Gyeong YUN, Daejeon (KR); CHANMI LEE, Daejeon (KR); Ki Seok JANG, Daejeon (KR)

(21) Appl. No.: 18/205,153

(22) Filed: Jun. 2, 2023

(30) Foreign Application Priority Data
Jun. 7, 2022 (KR) 10-2022-0068914
Jun. 2, 2023 (KR) 10-2023-0071533

(51) Int. Cl. C08G 77/18

(52) U.S. Cl. CPC C08G 77/18

(57) ABSTRACT

Provided is an organic-inorganic compound including a first structural body and a curable reactive group, wherein the first structural body may have a structure in which silane and isohexide are chemically bonded through a silyl ether bond.

### CROSS-REFERENCE TO RELATED APPLICATIONS

This U.S. non-provisional patent application claims priority under 35 U.S.C. § 119 of Korean Patent Application No. 10-2022-0068914, filed on Jun. 7, 2022, and Korean Patent Application No. 10-2023-0071533, filed on Jun. 2, 2023, the entire contents of which are hereby incorporated by reference.

### BACKGROUND

### 1. Field of the Invention

The present disclosure relates to an isohexide-based organic-inorganic compound including a curable reactive group and a silyl ether bond, a method for preparing the organic-inorganic compound, and a curable composition including the organic-inorganic compound.

### 2. Description of Related Art

As the demand for low-carbon and eco-friendliness is gradually increasing in order to respond to climate change and sustainable growth, efforts have been actively made to replace typical petroleum-based plastics with bio-based plastics. Particularly, isohexide is a 100% natural biomaterial using corn, sugar, wheat, potato, or the like as a raw material, and has no toxicity compared to a typical petrochemical-based bisphenol-based compound, but has similar mechanical properties thereof, so that isohexide-based plastics using isohexide are in the spotlight. However, isohexide-based plastics currently implemented meet the requirements for low-carbon and eco-friendliness, but do not implement remarkably superior properties compared to those of typical petrochemical-based plastics, so that there is a problem in that it is difficult to apply the isohexide-based plastics to high-tech materials such as displays and semiconductors.

### SUMMARY

The present disclosure provides an isohexide-based organic-inorganic compound including a curable reactive group and a silyl ether bond, and a curable composition including the organic-inorganic compound.

The present disclosure also provides a method for preparing an isohexide-based organic-inorganic compound including a curable reactive group and a silyl ether bond.

An embodiment of the inventive concept provides an organic-inorganic compound including a first structural body and a curable reactive group, wherein the first structural body may have a structure in which silane and isohexide are chemically bonded through a silyl ether bond.

In an embodiment, the organic-inorganic compound according to an embodiment of the inventive concept may satisfy Formula 1 below.

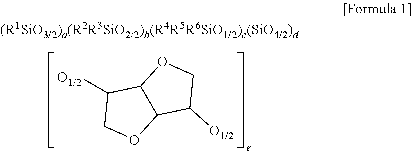

In an embodiment, in the above formula, a, b, and c may be 0 or positive numbers, and d and e may be positive numbers, R¹, R², R³, R⁴, R⁵, and R⁶ above may each independently be selected from the group consisting of a curable reactive group, a C₁ to C₂₀ alkyl group, a C₃ to C₈ cycloalkyl group, or a C₆ to C₂₀ aryl group, and at least one of R¹, R², R³, R⁴, R⁵, or R⁶ above may include a curable reactive group.

In an embodiment, the organic-inorganic compound may include a siloxane group bonded to the silyl ether group. In an embodiment, in the organic-inorganic compound according to an embodiment of the inventive concept, it may be that 0.1≤a+b+c≤0.9, 0≤d≤0.3, 0.1≤e≤0.9, and a+b+c+d+e=1. In an embodiment, the curable reactive group may be selected from the group consisting of an epoxy group, an amine group, an acryl group, a methacrylic group, a mercapto group, a carboxyl group, a vinyl group, a nitro group, a sulfone group, a hydroxyl group, a urethane group, ureide, isocyanate, an oxetane group, or combinations thereof.

In an embodiment, the isohexide may include at least one of isosorbide, isomanide, isoidide, or a combination thereof.

In an embodiment, the organic-inorganic compound according to an embodiment of the inventive concept may satisfy Formula 2 below.

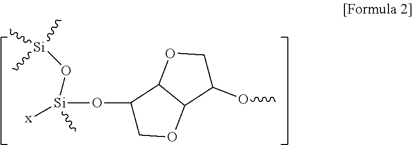

In an embodiment, in Formula 2 above, x may include the curable reactive group and a carbon compound, and n may be a positive number.

In an embodiment of the inventive concept, a method for preparing an organic-inorganic compound includes preparing a silane compound, preparing isohexide, and reacting the silane compound with the isohexide, wherein a silyl ether bond may be formed by reacting the silane compound with the isohexide.

In an embodiment, the silane compound may be selected from the group consisting of Formulas 4 to 7 below, or combinations thereof.

R¹Si(OR^{I})₃ [Formula 4]

R²R³Si(OR^{II})₂[Formula 5]

R⁴R⁵R⁶Si(OR^{III}) [Formula 6]

Si(OR^{IV})₄ [Formula 7]

In an embodiment, R¹, R², R³, R⁴, R⁵, and R⁶ above may each independently be selected from the group consisting of a curable reactive group, a C₁ to C₂₀ alkyl group, a C₃ to C₈ cycloalkyl group, or a C₆ to C₂₀ aryl group, at least one of R¹, R², R³, R⁴, R⁵, or R⁶ above may include a curable reactive group, and R^{I}, R^{II}, R^{III}, and R^{IV} above may each independently include hydrogen, a linear C₁ to C₆ alkyl group, and a branched C₁ to C₆ alkyl group.

In an embodiment, the molar ratio of the silane compounds of Formulas 4, 5, and 6 above to the total reactants may be defined as f, the molar ratio of the silane compound of Formula 7 above to the total reactants may be defined as g, and the molar ratio of the isohexide to the total reactants may be defined as h, wherein it may be that 0.1≤f≤0.9, 0≤g≤0.3, 0.1≤h≤0.9, and f+g+h=1.

In an embodiment, the method for preparing an organic-inorganic compound may further include forming a siloxane bond.

In an embodiment, in the method for preparing an organic-inorganic compound, the forming of the siloxane bond may include performing one or more reactions of a hydrolysis reaction or a condensation reaction between the silane compounds.

In an embodiment, the method for preparing an organic-inorganic compound may further reacting the silane compound with the isohexide, and using a catalyst to promote the forming of the siloxane bond, wherein the catalyst may be one of the group consisting of an acidic catalyst such as acetic acid, hydrochloric acid, hydrogen fluoride, sulfuric acid, nitric acid, chlorosulfonic acid, iodic acid, and pyrophosphoric acid, a basic catalyst such as potassium hydroxide, sodium hydroxide, barium hydroxide, and imidazole, and an ion exchange resin, water, and combinations thereof.

In an embodiment, in the method for preparing an organic-inorganic compound, the curable reactive group included in the silane compound may be an epoxy group and/or an oxetane group.

In an embodiment, in the method for preparing an organic-inorganic compound, the silane compound may be any one of 5,6-epoxyhexyltriethoxysilane, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, 3-Ethyl-3-[[3-(triethoxy silyl)propoxy]methyl]oxetane, 7-trimethoxysilyl-4-thia-heptanoic acid-(3-ethyl-oxetan-3-yl)methyl ester, N-(3-triethoxy silylpropyl)-(3-ethyloxetan-3-yl)-methyl carbamate, 2-(3-triethoxysilylpropylthio)succinic acid-bis-[(3-ethyloxetane-3-yl)-methyl]ester, (3,4-epoxycyclohexyl)ethyldimethoxysilane, 2-(3,4-epoxycyclohexyl)ethyl(methyl)dimethoxysilane, (3,4-epoxycyclohexyl)ethyldiethoxysilane, 2-(3,4-epoxycyclohexyl)ethyl(methyl)diethoxysilane, (2-(7-oxabicyclo[4.1.0]heptan-3-yl)ethyl)(methyl)silanediol, dimethoxy(methyl)(3-(oxiran-2-yl)propyl)silane, diethoxy(methyl)(3-(oxiran-2-yl)propyl)silane, methyl(3-(oxiran-2-yl)propyl)silanediol, (3-glycidoxypropyl)dimethoxymethylsilane, (3-glycidoxypropyl)diethoxymethylsilane, and (3-glycidoxypropyl)methylsilanediol, (3-glycidoxypropyl)dimethylethoxy silane, and 3-glycidoxypropyldimethylmethoxysilane.

In an embodiment, in the method for preparing an organic-inorganic compound, the curable reactive group included in the silane compound may include one or more among an amine group, a ureide group, an isocyanate group, and a mercapto group.

In an embodiment, in the method for preparing an organic-inorganic compound, the silane compound may be any one of 4-aminobutyltriethoxysilane, 4-amino-3,3-dimethylbutyltrimethoxysilane, N-2-(Aminoethyl)-3-aminopropyltrimethoxysilane, N-(6-aminohexyl)aminomethyltriethoxysilane, N-(6-aminohexyl)aminopropyltrimethoxysilane, n-(2-aminoethyl)-11-aminoundecyltrimethoxysilane, N-(2-aminoethyl)-3-aminopropylsilanetriol, 3-Aminopropyltrimethoxysilane, 3-Aminopropyltriethoxysilane, 3-Triethoxysilyl-N-(1,3 dimethyl-butylidene) propylamine, N-Phenyl-3-aminopropyltrimethoxysilane, N-(Vinylbenzyl)-2-aminoethyl3-aminopropyltrimethoxysilane hydrochloride, 3-(m-aminophenoxy)propyltrimethoxysilane, m-aminophenyltrimethoxysilane, p-aminophenyltrimethoxysilane, aminophenyltrimethoxysilane, 3-aminopropyltris(methoxyethoxyethoxy)silane, 11-aminoundecyltriethoxysilane, 2-(4-pyridylethyl)triethoxysilane, 2-(2-pyridylethyl)trimethoxysilane, N-(3-trimethoxysilylpropyl)pyrrole, 3-aminopropylsilanetriol, (aminoethylaminomethyl)phenethyltrimethoxysilane, 3-ureidopropyltrialkoxysilane, 3-isocyanatepropyltriethoxy silane, 3-mercaptopropyltrimethoxysilane, N-2-(Aminoethyl)-3-aminopropylmethyldimethoxysilane, N-(2-aminoethyl)-3-aminopropylmethyldiethoxysilane, N-(2-aminoethyl)-3-aminoisobutylmethyldimethoxysilane, 4-amino-3,3-dimethylbutylmethyldimethoxysilane, 3-aminopropylmethyldiethoxysilane, 3-Mercaptopropylmethyldimethoxysilane, 1-amino-2-(dimethylethoxysilyl)propane, 3-aminopropyldiisopropylethoxysilane, 3-aminopropyldimethylethoxysilane, and N-(2-aminoethyl)-3-aminoisobutyldimethylmethoxysilane.

In an embodiment of the inventive concept, a curable composition includes an organic-inorganic compound including a first structural body and a curable reactive group, and a curing agent, wherein the first structural body may have a structure in which silane and isohexide are chemically bonded through a silyl ether bond, and the curable reactive group may be any one of an epoxy group, an oxetane group, or a combination thereof.

In an embodiment, the curing agent may further include an initiator, a reactive diluent, and an additive, wherein the curing agent may be any one of a silyl ether isohexide-based organic-inorganic compound having an amine group, a ureide group, an isocyanate group, or a mercapto group as a curing reactive group, an acid-based curing agent, an amine-based curing agent, an imidazole-based curing agent, a carboxylic acid-based curing agent, a phosphine-based curing agent, a urea derivative-based curing agent, and a combination thereof, the initiator may be any one of a photoacid generator, a photobase generator, a thermal acid generator, and a combination thereof, the reactive diluent may be any one of an epoxy reactive diluent, an oxetane reactive diluent, polyethylene glycol, and a combination thereof, and the additive may be any one of graphene, carbon nanotube, fullerene, hexagonal boron nitride, boron nitride nanotube, alumina, MXene, and a combination thereof.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIGS. 1 and 2 are graphs for describing a typical isohexide-based epoxy resin;

FIGS. 3 and 4 are graphs for describing an isohexide-based compound according to an embodiment of the inventive concept; and

FIG. 5 is a graph for describing an isohexide-based compound according to an embodiment of the inventive concept.

### DETAILED DESCRIPTION OF EMBODIMENTS

Advantages and features of the inventive concept, and methods for achieving the same will become clear with reference to the following detailed description of exemplary embodiments and the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art to which the inventive concept pertains. The inventive concept will only be defined by the appended claims. The same reference numerals refer to like elements throughout the specification.

The terms used herein are for the purpose of describing embodiments and are not intended to be limiting of the present invention. In the present disclosure, singular forms include plural forms unless the context clearly indicates otherwise. As used herein, the terms “comprises” and/or “comprising” are intended to be inclusive of the stated elements, steps, operations and/or devices, and do not exclude the possibility of the presence or the addition of one or more other elements, steps, operations, and/or devices.

In addition, embodiments described in the present disclosure will be described with reference to cross-sectional views and/or plan views which are ideal exemplary drawings of the inventive concept. In the drawings, the thickness of films and regions are exaggerated for an effective description of technical contents. Accordingly, the shape of an exemplary drawing may be modified by manufacturing techniques and/or tolerances. Thus, the embodiments of the inventive concept are not limited to specific forms illustrated, but are intended to include changes in the form generated by a manufacturing process. Thus, the regions illustrated in the drawings have schematic properties, and the shapes of the regions illustrated in the drawings are intended to exemplify specific shapes of regions of a device and are not intended to limit the scope of the inventive concept.

Unless otherwise defined, terms used in the embodiments of the inventive concept may be interpreted as meanings commonly known to those skilled in the art.

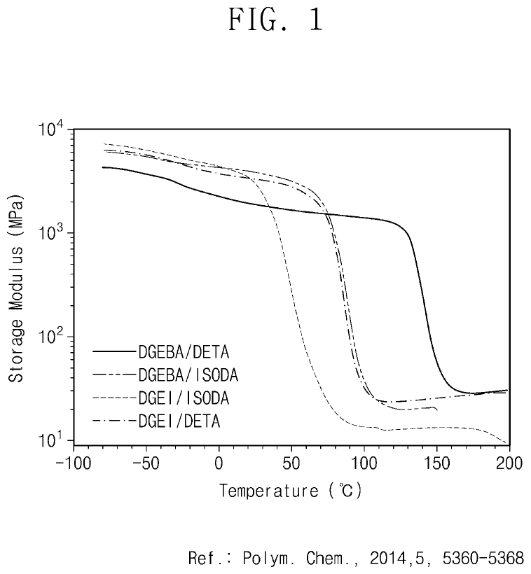

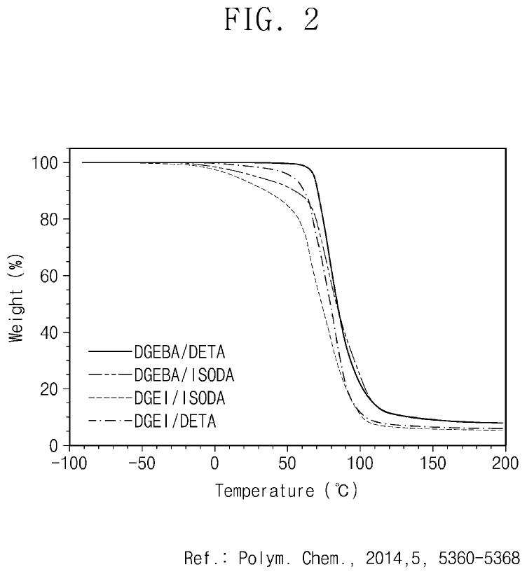

FIGS. 1 and 2 are graphs of one example which compares characteristics of petrochemical-based plastics and those of typical bioplastics.

Among typical petrochemical-based plastics, bisphenol-based resins in particular have excellent strength and heat resistance, and thus are applied in a considerable number of fields, but due to a problem in that the bisphenol-based resins may cause endocrine disruption, there is an increasing demand for eco-friendly bioplastics. In addition, as the need to replace typical petrochemical-based plastics with bioplastics in order to cope with low-carbon policies such as Carbon Border Adjustment Mechanism for carbon neutrality, isohexide-based bioplastics have been emerged as an alternative to the typical petrochemical-based plastics.

The isohexide-based bioplastics may include an isohexide-based epoxy resin based on isohexide derived from corn starch.

Referring to FIG. 1, characteristics of a bisphenol epoxy resin (DGEBA), which is a petrochemical-based plastic, and an amine curing agent (DETA), and an isosorbide-based epoxy resin (DGEI), which is an isohexide-based plastic, and an isosorbide-based amine curing agent (ISODA) are illustrated.

The graph in FIG. 1 shows the analysis of diglycidyl ether of bisphenol A/diethylene triamine (DGEBA/DETA), diglycidyl ether of bisphenol A/isosorbide diamine (DGEBA/ISODA), and diglycidyl ethers of isosorbide/isosorbide diamine (DGEI/ISODA), and diglycidyl ethers of isosorbide/diethylene triamine (DGEI/DETA) obtained by dynamic mechanical analysis (DMA). The y-axis of the graph in FIG. 1 represents the storage modulus (MPa), and the x-axis represents the temperature (° C.). Referring to FIG. 1, the storage modulus of each of DGEBA/ISODA, DGEI/DETA, and DGEI/ISODA including isohexide-based plastics rapidly decreases compared to that of DGEBA/DETA at a significantly low temperature.

Referring to FIG. 2, characteristics of a bisphenol epoxy resin (DGEBA), which is a petrochemical-based plastic, and an amine curing agent (DETA), and an isosorbide-based epoxy resin (DGEI), which is an isohexide-based plastic, and an isosorbide-based amine curing agent (ISODA) are illustrated. The graph in FIG. 2 shows the analysis of DGEBA/DETA, DGEBA/ISODA, DGEI/ISODA, and DGEI/DETA obtained by thermogravimetric analysis (TGA).

Referring to the graph in FIG. 2, the wt % that is thermally decomposed according to a temperature is illustrated.

The y-axis in FIG. 2 represents the weight (%), and the x-axis therein represents the temperature (° C.). The temperature at which 5 wt % thermal decomposition occurs may be highest for DGEBA/DETA, which is a petrochemical-based plastic, and may decrease in the order of DGEI/DETA, DGEBA/ISODA, and DGEI/ISODA, which include isohexide-based plastics.

Referring to FIG. 1 and FIG. 2, the thermal physical properties of petrochemical-based plastics may be more excellent than those of typical bioplastics.

An organic-inorganic compound according to the inventive concept may be a silyl ether isohexide-based organic-inorganic compound.

The organic-inorganic compound according to the inventive concept may include an isohexide-derived molecular structure having a silyl ether group and a curable reactive group. The organic-inorganic compound according to the inventive concept may satisfy Formula 1 below. Formula 1 may be an average unit formula.

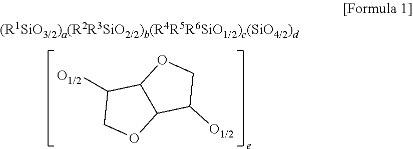

In the above formula, R¹, R², R³, R⁴, R⁵, and R⁶ above may each independently be selected from the group consisting of a curable reactive group, a C₁ to C₂₀ alkyl group, a C₃ to C₈ cycloalkyl group, or a C₆ to C₂₀ aryl group, and at least one of R¹, R², R³, R⁴, R⁵, or R⁶ above may include a curable reactive group.

The curable reactive group may be selected from the group consisting of an epoxy group, an amine group, an acryl group, a methacrylic group, a mercapto group, a carboxyl group, a vinyl group, a nitro group, a sulfone group, a hydroxyl group, a urethane group, an oxetane group, or combinations thereof.

In Formula 1 above, b and c are each 0 or a positive number, wherein 0.1≤a+b+c≤0.9, 0≤d≤0.3, 0.1≤e≤0.9, and a+b+c+d+e=1. When the a+b+c is less than 0.1, there are relatively few silane compounds capable of forming a silyl ether bond with isohexide, so that the synthesis may not be achieved, and when 0.9 or greater, it may be difficult to cope with eco-friendly policies due to a low content of biocarbon based on isohexide. When the d is 0.3 or greater, a chemical reaction may be excessively performed to cause gelation. When the e is 0.1 or less, it may be difficult to cope with eco-friendly policies due to a low content of biocarbon based on isohexide, and when 0.9 or greater, there are relatively few silane compounds capable of forming a silyl ether bond with isohexide, so that the synthesis may not be achieved.

According to an embodiment of the inventive concept, an isohexide-based organic-inorganic compound may include a plurality of (R¹SiO_{3/2}) units, (R²R³SiO_{2/2}) units, (R⁴R⁵R⁶SiO_{1/2}) units, and (SiO_{4/2}) units in Formula 1 above, each independently. For example, an isohexide-based organic-inorganic compound including three (R¹SiO_{3/2}) units, two (R²R³SiO_{2/2}) units, one (R⁴R⁵R⁶SiO_{1/2}) unit, and one (SiO_{4/2}) unit may be represented by an average unit formula of Formula Z below.

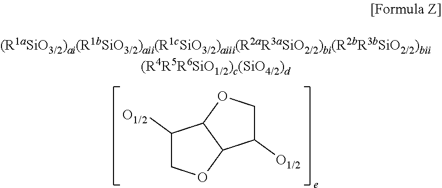

In Formula Z above, R^{1a}, R^{1b}, and R^{1c} are each the same as defined in R¹ of Formula 1 above, and ai, aii, and aiii are each 0 or a positive number, wherein the sum thereof is a as defined in Formula 1 above. R^{2a} and R^{2b} are each the same as defined in R² of Formula 1 above, R^{3a} and R^{3b} are each the same as defined in R³ of Formula 1 above, bi and bii are each 0 or a positive number, wherein the sum thereof is b as defined in Formula 1 above. At least one of R^{1a}, R^{1b}, R^{1c}, R^{2a}, R^{2b}, R^{3a}, R^{3b}, R⁴, R⁵, or R⁶ of Formula 2 above includes a curable reactive group.

The isohexide may include at least one of isosorbide, isomanide, isoidide, or a combination thereof.

The isohexide-based organic-inorganic compound according to the inventive concept necessarily includes a silyl ether bond in the molecule and may additionally include a siloxane bond, and thus may implement excellent thermal and mechanical properties compared to those of a typical isohexide-based organic compound. In this case, the organic-inorganic compound may satisfy Formula 2 below. As part of the molecular structure of an embodiment, the silyl ether bond and the siloxane bond respectively refer to a Si—O—C bond and a Si—O—Si bond, as represented in Formula 2 below.

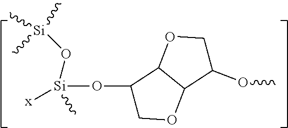

In Formula 2 above, x may include the curable reactive group and a carbon compound, and n may be a positive number.

The x may satisfy Formula 3 below.

(R¹SiO_{3/2})ₐ(R²R³SiO_{2/2})_{b}(R⁴R⁵R⁶SiO_{1/2})_{c}(SiO_{4/2})_{d} [Formula 3]

In this case, R¹, R², R³, R⁴, R⁵, and R⁶ above may each independently be selected from the group consisting of a curable reactive group, a C₁ to C₂₀ alkyl group, a C₃ to C₈ cycloalkyl group, or a C₆ to C₂₀ aryl group, and at least one of R¹, R², R³, R⁴, R⁵, or R⁶ above may include a curable reactive group, and a, b, c, and d above may be positive numbers. In this case, it may be that 0.1≤a+b+c≤0.9, and 0≤d≤0.3.

A method for preparing an organic-inorganic compound according to an embodiment of the inventive concept may include preparing a silane compound, preparing isohexide, and reacting the silane compound with the isohexide, wherein a silyl ether bond may be formed by reacting the silane compound with the isohexide.

The reacting of the silane compound with the isohexide may include forming a silyl ether bond through a condensation reaction.

The silane compound may be selected from the group consisting of Formulas 4 to 7 below, or combinations thereof.

R¹Si(OR^{I})₃ [Formula 4]

R²R³Si(OR^{II})₂ [Formula 5]

R⁴R⁵R⁶Si(OR^{III}) [Formula 6]

Si(OR^{IV})₄ [Formula 7]

R¹, R², R³, R⁴, R⁵, and R⁶ above may each independently be selected from the group consisting of a curable reactive group, a C₁ to C₂₀ alkyl group, a C₃ to C₈ cycloalkyl group, or a C₆ to C₂₀ aryl group, at least one of R¹, R², R³, R⁴, R⁵, or R⁶ above may include a curable reactive group, and R^{I}, R^{II}, R^{III}, and R^{IV} above may each independently include hydrogen, a linear C₁ to C₆ alkyl group, and a branched C₁ to C₆ alkyl group.

The isohexide may include isomanide, isosorbide, and isoidide, which are three types of isomers.

The molar ratio of silanes represented by Formulas 4, 5, and 6 to the total reactants is in the range of 0.1 to 0.9, the molar ratio of silanes represented by Formula 7 to the total reactants is in the range of 0 to 0.3, and the molar ratio of isohexide to the total reactants is in the range of 0.1 to 0.9.

That is, the molar ratio of the silane compounds of Formulas 4, 5, and 6 above to the total reactants may be defined as f, the molar ratio of the silane compound of Formula 7 above to the total reactants may be defined as g, and the molar ratio of the isohexide to the total reactants may be defined as h, wherein it may be that 0.1≤f≤0.9, 0≤g≤0.3, 0.1≤h≤0.9, and f+g+h=1. When the f is less than 0.1, there are relatively few silane compounds capable of forming a silyl ether bond with isohexide, so that the synthesis may not be achieved, and when 0.9 or greater, it may be difficult to cope with eco-friendly policies due to a low content of biocarbon based on isohexide. When the g is 0.3 or greater, a chemical reaction may be excessively performed to cause gelation. When the h is 0.1 or less, it may be difficult to cope with eco-friendly policies due to a low content of biocarbon based on isohexide, and when 0.9 or greater, there are relatively few silane compounds capable of forming a silyl ether bond with isohexide, so that the synthesis may not be achieved. According to an embodiment of the inventive concept, the isohexide-based organic-inorganic compound may be prepared by including a plurality of compounds represented by Formulas 4, 5, 6, and 7 above and isohexide, each independently. For example, the isohexide-based organic-inorganic compound may be prepared by a condensation reaction of three types of silanes [R^{1a}Si(OR^{Ia})₃, R^{1b}Si(OR^{Ib})₃, and R^{1c}Si(OR^{Ic})₃] represented by Formula 4, two types of silanes [R^{2a}R^{3a}(SiOR^{IIa})₂ and R^{2b}R^{3b}(SiOR^{IIb})₂] represented by Formula 5, one type of silane [R⁴R⁵R⁶SiOR^{III}] represented by Formula 6, one type of silane [Si(OR^{IV})₄] represented by Formula 7, and two types of isohexides [isomanide and isosorbide]. At this time, R^{1a}, R^{1b}, and R^{1c} are each the same as defined in R¹ of Formula 4 above, and R^{1a}, R^{1b}, and R^{1c} are each the same as defined in R^{I} of Formula 4 above, R^{2a} and R^{2b} are each the same as defined in R² of Formula 5 above, and R^{3a} and R^{3b} are each the same as defined in R³ of Formula 6 above, and R^{IIa} and R^{IIb} are each the same as defined in R^{II} of Formula 7 above.

According to an embodiment of the inventive concept, the curable reactive group may be selected from the group consisting of an epoxy group, an amine group, an acryl group, a methacrylic group, a mercapto group, a carboxyl group, a vinyl group, a nitro group, a sulfone group, a hydroxyl group, a urethane group, ureide, isocyanate, an oxetane group, or combinations thereof. Among the curable reactive groups, an epoxy group and an oxetane group may be preferred for use in the field of adhesive materials in the semiconductor and display fields, wherein the epoxide group may include a glycidyl epoxy group and a paper cyclic epoxy group.

A silyl ether isohexide-based organic-inorganic compound having an epoxy group and/or an oxetane group as the curable reactive group be prepared by using a silane compound having an epoxy group and/or an oxetane group. Specifically, a silane compound corresponding to Formula 4 above among silane compounds having an epoxy group and/or an oxetane group may be selected from 5,6-epoxyhexyltriethoxysilane, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, 3-Ethyl-3-[[3-(triethoxysilyl)propoxy]methyl]oxetane, 7-trimethoxysilyl-4-thia-heptanoic acid-(3-ethyl-oxetan-3-yl)methyl ester, N-(3-triethoxy silylpropyl)-(3-ethyloxetan-3-yl)-methyl carbamate, and 2-(3-triethoxysilylpropylthio)succinic acid-bis-[(3-ethyloxetane-3-yl)-methyl]ester. Specifically, a silane compound corresponding to Formula 5 above among silane compounds having an epoxy group and/or an oxetane group may be selected from (3,4-epoxycyclohexyl)ethyldimethoxysilane, 2-(3,4-epoxycyclohexyl)ethyl(methyl)dimethoxysilane, (3,4-epoxycyclohexyl)ethyldiethoxysilane, 2-(3,4-epoxycyclohexyl)ethyl(methyl)diethoxysilane, (2-(7-oxabicyclo[4.1.0]heptan-3-yl)ethyl)(methyl)silanediol, dimethoxy(methyl)(3-(oxiran-2-yl)propyl)silane, diethoxy(methyl)(3-(oxiran-2-yl)propyl)silane, methyl(3-(oxiran-2-yl)propyl)silanediol, (3-glycidoxypropyl)dimethoxymethylsilane, (3-glycidoxypropyl)diethoxymethylsilane, and (3-glycidoxypropyl)methylsilanediol. Specifically, a silane compound corresponding to Formula 6 above among silane compounds having an epoxy group and/or an oxetane group may be selected from (3-glycidoxypropyl)dimethylethoxysilane and 3-glycidoxypropyldimethylmethoxysilane. In an embodiment, the reaction of a silane compound and isohexide may not only form a silyl ether bond, but also additionally form a siloxane bond. In this case, the isohexide-based organic-inorganic compound may be prepared by additionally forming a siloxane bond through a hydrolysis reaction and/or a condensation reaction between the silane compounds represented by Formulas 4, 5, 6, and 7 above. For the hydrolysis reaction, water may be additionally introduced to a reactant.

A catalyst may be used to promote the condensation reaction between a silane compound and isohexide and the hydrolysis reaction and/or the condensation reaction between the silane compounds, wherein the catalyst may be selected from an acidic catalyst, a basic catalyst, an ion exchange resin, water, and a combination thereof.

Specifically, the catalyst may be selected from the group consisting of an acidic catalyst such as acetic acid, hydrochloric acid, hydrogen fluoride, sulfuric acid, nitric acid, chlorosulfonic acid, iodic acid, and pyrophosphoric acid, a basic catalyst such as potassium hydroxide, sodium hydroxide, barium hydroxide, and imidazole, and an ion exchange resin, water, and combinations thereof.

A curable composition according to an embodiment of the inventive concept may include a silyl ether isohexide-based organic-inorganic compound having an epoxy group and/or an oxetane group, and one or more of a curing agent, an initiator, an additive, or a reactive diluent.

The curing agent may be selected from a silyl ether isohexide-based organic-inorganic compound having an amine group and/or a ureide group and/or an isocyanate group and/or a mercapto group as a curable reactive group, an acid-based curing agent, an amine-based curing agent, an imidazole-based curing agent, a carboxylic acid-based curing agent, a phosphine-based curing agent, a urea derivative-based curing agent, and a combination thereof.

The silyl ether isohexide-based organic-inorganic compound having an amine group and/or a ureide group and/or an isocyanate group and/or a mercapto group as a curable reactive group may satisfy Formula 1 above.

The silyl ether isohexide-based organic-inorganic compound having an amine group and/or a ureide group and/or an isocyanate group and/or a mercapto group as a curable reactive group may be prepared by using a silane compound having an amine group and/or a ureide group and/or an isocyanate group and/or a mercapto group. Specifically, a silane compound corresponding to Formula 4 above among silane compounds having an amine group and/or a ureide group and/or an isocyanate group and/or a mercapto group may be selected from 4-aminobutyltriethoxy silane, 4-amino-3,3-dimethylbutyltrimethoxysilane, N-2-(Aminoethyl)-3-aminopropyltrimethoxysilane, N-(6-aminohexyl)aminomethyltriethoxysilane, N-(6-aminohexyl)aminopropyltrimethoxysilane, n-(2-aminoethyl)-11-aminoundecyltrimethoxysilane, N-(2-aminoethyl)-3-aminopropylsilanetriol, 3-Aminopropyltrimethoxysilane, 3-Aminopropyltriethoxysilane, 3-Triethoxysilyl-N-(1,3 dimethyl-butylidene) propylamine, N-Phenyl-3-aminopropyltrimethoxysilane, N-(Vinylbenzyl)-2-aminoethyl3-aminopropyltrimethoxysilane hydrochloride, 3-(m-aminophenoxy)propyltrimethoxysilane, m-aminophenyltrimethoxysilane, p-aminophenyltrimethoxysilane, aminophenyltrimethoxysilane, 3-aminopropyltris(methoxyethoxyethoxy)silane, 11-aminoundecyltriethoxysilane, 2-(4-pyridylethyl)triethoxysilane, 2-(2-pyridylethyl)trimethoxysilane, N-(3-trimethoxy silylpropyl)pyrrole, 3-aminopropylsilanetriol, (aminoethylaminomethyl)phenethyltrimethoxysilane, 3-ureidopropyltrialkoxysilane, 3-isocyanatepropyltriethoxysilane, and 3-mercaptopropyltrimethoxysilane. Specifically, a silane compound corresponding to Formula 5 above among silane compounds having an amine group and/or a ureide group and/or an isocyanate group and/or a mercapto group may be selected from N-2-(Aminoethyl)-3-aminopropylmethyldimethoxysilane, N-(2-aminoethyl)-3-aminopropylmethyldiethoxysilane, N-(2-aminoethyl)-3-aminoisobutylmethyldimethoxysilane, 4-amino-3,3-dimethylbutylmethyldimethoxysilane, 3-aminopropylmethyldiethoxysilane, and 3-Mercaptopropylmethyldimethoxysilane. Specifically, a silane compound corresponding to Formula 6 above among silane compounds having an amine group and/or a ureide group and/or an isocyanate group and/or a mercapto group may be selected from 1-amino-2-(dimethylethoxysilyl)propane, 3-aminopropyldiisopropylethoxysilane, 3-aminopropyldimethylethoxysilane, and N-(2-aminoethyl)-3-aminoisobutyldimethylmethoxysilane.

Specifically, the acid-based curing agent may be selected from phthalic anhydride, trimellitic anhydride, pyromellitic dianhydride, benzophenonetetracarboxylic dianhydride, maleic anhydride, tetrahydrophthalic anhydride, methyltetrahydrophthalic anhydride, endomethylenetetrahydrophthalic anhydride, methylendomethylenetetrahydrophthalic anhydride, methylbutenyltetrahydrophthalic anhydride, dodecenylsuccinic anhydride, hexahydrophthalic anhydride, methylhexahydrophthalic anhydride, succinic anhydride, methylcyclohexenedicarboxylic anhydride, chlorendic anhydride, and a combination thereof, and a chemical reactant thereof.

Specifically, the amine-based curing agent may be selected from diethylenetriamine, triethylenediamine, triethylenetetraamine, tetraethylenepentamine, diethylaminopropyleneamine, aminoethylpiperazine, menthanediamine, isoprondiamine, metaphenylenediamine, diaminodiphenylmethane, diaminodiphenylsulfone, 2-methyl-4-nitro aniline, dicyandiamide, triethylamine, benzyldimethylamine, methylbenzyldimethylamine, 2-(dimethylaminomethyl)phenol, 2,4,6-tris(dimethylaminomethyl)phenol, 1,8-diazabicyclo[5,4,0]undecene-7,1,5-diazabicyclo[4.3.0]non-5-en, boron trichloride, boron trifluoride, and a combination thereof, and a chemical reactant thereof.

Specifically, the imidazole curing agent may be selected from 2-methylimidazole, 2-ethyl-4-methylimidazole, 2,4-dimethylimidazole, 2-phenylimidazole, 2-phenyl-4-methylimidazole, 1-cyanoethyl-2-undecylimidazolium trimellitate, an epoxy imidazole adduct, a microcapsule-type latent curing agent in a form in which an imidazole series is used as a nucleus and the surface thereof is coated with a polymer series, and a combination thereof, and a chemical reactant thereof.

Specifically, the carboxylic acid curing agent may be selected from alpha(α)-amino acid, beta(β)-amino acid, gamma(γ)-amino acid, delta(δ)-amino acid, anthranilic acid, 3-aminobenzoic acid, paraaminobenzoic acid, and a combination thereof, but may not be limited thereto. Specifically, a reducing curing agent may be selected from a carboxylic acid such as glycine, alanine, valine, leucine, isoleucine, lysine, arginine, histidine, aspartic acid, asparagine, glutamine, phenylalanine, tyrosine, tryptophan, cysteine, methionine, serine, ornithine, 3-phenylserine, threonine, L-dopa, norleucine, penicillamine, sarcosine, proline, hydroxyproline, 3-hydroxyproline, 3,4-dihydroproline, pipecolic acid, p-alanine, 3-aminobutyric acid, isoserine, 3-aminoisobutyric acid, 3-amino-2-phenylpropionic acid, 3-amino-5-methylhexanoic acid, 3-amino-4-phenylbutyric acid, 3-amino-4-hydroxybutyric acid, 3-amino-4-hydroxypentanoic acid, 3-amino-4-methylpentanoic acid, 3-amino-3-phenylpropionic acid, pyrrolidine-3-carboxylic acid, γ-aminobutyric acid, 4-amino-3-hydroxybutyric acid, 3-pyrrolidine-2-yl-propionic acid, 3-aminocyclohexanecarboxylic acid, 4-guanidinobutyric acid, 4-aminobenzoic acid, 3-aminobenzoic acid, 2-aminobenzoic acid, 3,5-diaminobenzoic acid, 4-aminosalicylic acid, 5-aminosalicylic acid, 3-aminoisonicotinic acid, 4-aminonicotinic acid, 5-aminonicotinic acid, 2-aminonicotinic acid, 6-aminonicotinic acid, 2-aminoisonicotinic acid, 6-aminopicolinic acid, formic acid, acetic acid, propionic acid, butyric acid, valeric acid, caproic acid, caprylic acid, decanoic acid, lauric acid, myristic acid, palmitic acid, stearic acid, oleic acid, linoleic acid, alpha-linolenic acid, cyclohexanecarboxylic acid, phenylacetic acid, benzoic acid, chlorobenzoic acid, bromobenzoic acid, nitrobenzoic acid, phthalic acid, isophthalic acid, terephthalic acid, salicylic acid, hydroxybenzoic acid, anthranilic acid, aminobenzoic acid, methoxybenzoic acid, glutaric acid, maleic acid, azelaic acid, abietic acid, adipic acid, ascorbic acid, acrylic acid, citric acid, and a combination thereof, and a chemical reactants thereof.

The initiator may be selected from a photoacid generator, a photobase generator, a thermal acid generator, and a combination thereof. Specifically, the initiator may be selected from ytterbium trifluoromethenesulfonate salt, samarium trifluoromethenesulfonate salt, erbium trifluoromethenesulfonate salt, lanthanum trifluoromethenesulfonate salt, tetrabutylphosphonium methane sulfonate salt, ethyltriphenylphosphonium bromide salt, 3-methyl-2-butenyltetramethylenesulfonium hexafluoroantimonate salt, triarylsulfonium hexafluoroantimonate salt, triarylsulfonium hexafluorophosphate salt, 9-(4-hydroxyethoxyphenyl)cyanthrenium hexafluoroantimonium salt, 1-(3-methylbut-2-enyl)tetrahydro-1H-thiophenium hexafluoroantimonate salt, diphenyldiodonium hexafluoroantimonate salt, diphenyldiodonium hexafluorophosphate salt, ditoliliodonium hexafluorophosphate salt, triflic acid salt, and a combination thereof, and a chemical reactant thereof.

The reactive diluent may be selected from an epoxy reactive diluent, an oxetane reactive diluent, polyethylene glycol, and a combination thereof.

Specifically, the epoxy reactive diluent may be selected from 2-ethylhexyl glycidyl ether, allyl glycidyl ether, polypropylene glycol glycidyl ether-H, polypropylene glycol glycidyl ether-S, n-butyl glycidyl ether, phenyl glycidyl ether, 4-vinylcyclohexene dioxide, cyclohexene vinyl monoxide, (3,4-epoxycyclohexyl)methyl 3,4-epoxycyclohexylcarboxylate, 3,4-epoxycyclohexylmethyl methacrylate, 3,4-epoxycyclohexanecarboxylate, 2-(3,4-epoxycyclohexyl)-1,3-dioxolane, and bis(3,4-epoxycyclohexylmethyl)adipate, and a combination thereof, and a chemical reactant thereof.

Specifically, the oxetane reactive diluent may be selected from 3-methyloxetane, 2-methyloxetane, 3-oxetanol, 2-methyleneoxetane, 3-methyl-3-hydroxymethyloxetane, 3-ethyl-3-hydroxymethyloxetane, 3,3-oxetanedimethane thiol, 2-ethylhexyl oxetane, 4-(3-methyloxetane-3-yl) benzonitrile, N-(2,2-dimethylpropyl)-3-methyl-3-oxetanemethanamine, N-(1,2-dimethylbutyl)-3-methyl-3-oxetanennethanannine, xylylene bisoxetane, and 3-ethyl-3[{(3-ethyloxetane-3-yl)methoxy}methyl]oxetane, (3-ethyloxetane-3-yl)methyl (meth)acrylate, and 4-[(3-ethyloxetane-3-yl)methoxy]butan-1-ol, and a combination thereof, and a chemical reactant thereof.

The additive may be selected from graphene, carbon nanotube, fullerene, hexagonal boron nitride, boron nitride nanotube, alumina, MXene, and a combination thereof.

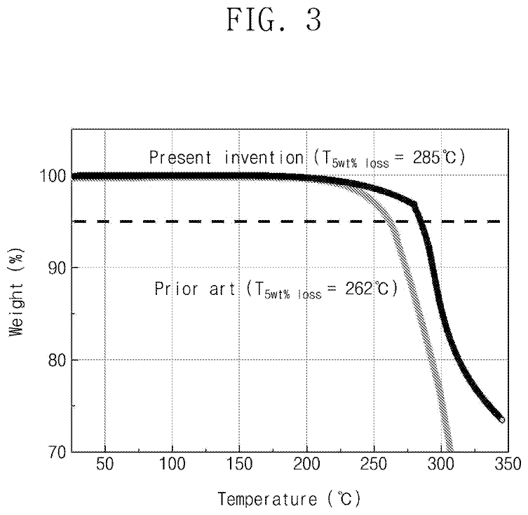

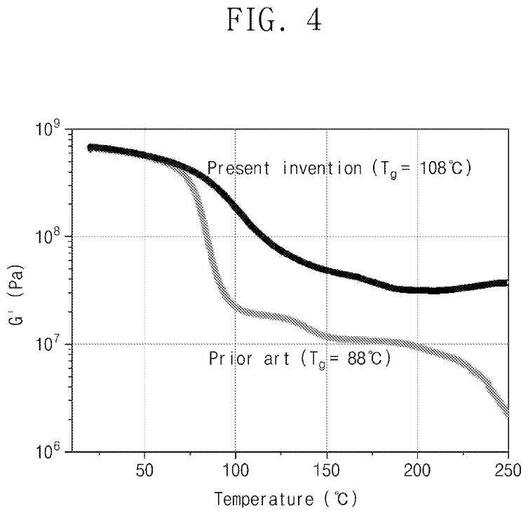

FIGS. 3 and 4 are graphs for describing excellent properties of a cured product including the isohexide-based compound according to an embodiment of the inventive concept compared to those of a cured product including a typical petrochemical-based compound.

Referring to FIG. 3, thermal decomposition properties of the cured product including the isohexide-based compound according to an embodiment of the inventive concept are illustrated. The properties of a cured product including an isohexide-based organic-inorganic compound containing silyl ether may be denoted as the present invention, and the properties of a cured product including a typical petrochemical-based compound may be denoted as the prior art.

The x-axis of FIG. 3 is the temperature (° C.), and the y-axis thereof is the weight (%). The temperature at which 5% of the weight of the cured product including the isohexide-based organic-inorganic compound containing silyl ether of the present invention is thermally decomposed is 285° C., and the temperature at which 5% of the weight of the cured product including a typical petrochemical-based compound is thermally decomposed is 262° C. The graph in FIG. 3 shows the analysis result obtained by TGA analysis (10° C./min, N₂).

Referring to FIG. 4, thermomechanical properties of the cured product including the isohexide-based compound according to an embodiment of the inventive concept are illustrated. The properties of the cured product including an isohexide-based organic-inorganic compound containing silyl ether may be denoted as the present invention, and the properties of the cured product including a typical petrochemical-based compound may be denoted as the prior art.

The x-axis of FIG. 4 is the temperature (° C.), and the y-axis thereof is the pressure (Pa). The glass transition temperature T g of the cured product including the isohexide-based organic-inorganic compound containing silyl ether of the inventive concept is 108° C., and the glass transition temperature T g of the cured product including a typical petrochemical-based compound is 88° C. The graph in FIG. 4 shows the analysis result obtained by Rheometer analysis (10° C./min, CD 5%, 1 Hz).

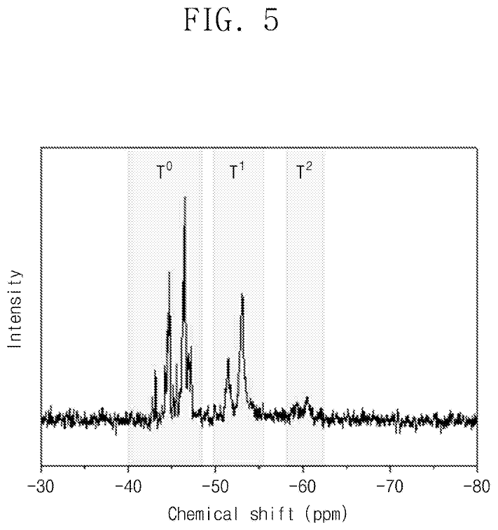

FIG. 5 is a graph for describing an isohexide-based organic-inorganic compound according to an embodiment of the inventive concept.

Referring to FIG. 5, the result of 29-Si-NMR analysis of an isohexide-based organic-inorganic compound of the inventive concept according to Example 1 to be described later is shown.

Tⁿ (n=0, 1, 2, 3) is a general method of denoting a siloxane bond, wherein T indicates that there are three Si—O bonds with respect to a target Si atom, and n indicates the number of siloxane bonds (Si—O—Si) with respect to a target Si atom. As can be seen from FIG. 5, it can be seen that the synthesized isohexide-based organic-inorganic compound includes three types of T⁰ series, two types of T¹ series, and one type of T² series, and since an unreacted T⁰ series (−42 ppm) was not detected, it can be inferred that the methoxy group of ECTMS reacted with the alcohol group of isosorbide and formed a silyl ether bond.

### EXAMPLES

### Example 1

2-(3,4-epoxycyclohexyl)ethyltrimethoxysilane (ECTMS, Sigma-Aldrich Company), isosorbide (Sigma-Aldrich Company), and Amberlite IRA-400 (Sigma-Aldrich Company) were introduced at a ratio of 19.7 g:17.5 g:3.1 g into a 2-neck flask with a capacity of 100 ml, and stirred at 80° C. for 24 hours to obtain an isohexide-based organic-inorganic compound having an average unit formula of Formula 8 below.

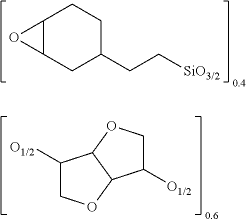

[Formula 8] Average unit formula of the isohexide-based organic-inorganic compound of Example 1

As a result of performing measurements by gel permeation chromatography (GPC) to analyze the molecular weight of the synthesized isohexide-based organic-inorganic compound, it was confirmed that the compound had a number average molecular weight of about 2,500, a weight average molecular weight of about 12,000, and a polydispersity index (PDI) of about 4.9.

As a result of measuring the biocarbon content of the synthesized isohexide-based organic-inorganic compound according to the ASTM D 6866 standard, it was confirmed that the compound contained about 50.6% of biocarbon.

### Example 2

2-(3,4-epoxycyclohexyl)ethyltrimethoxysilane (ECTMS, Sigma-Aldrich Company), trimethylmethoxysilane (Sigma-Aldrich Company), isosorbide (Sigma-Aldrich Company), and Amberlite IRA-400 (Sigma-Aldrich Company) were introduced at a ratio of 19.9 g:1.7 g:33.0 g:3.8 g into a 2-neck flask with a capacity of 200 ml, and stirred at 80° C. for 24 hours to obtain an isohexide-based organic-inorganic compound having an average unit formula of Formula 9 below.

[Formula 9] Average unit formula of isohexide-based organic-inorganic compound of Example 2

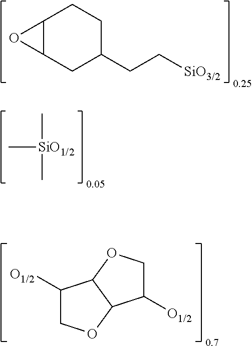

As a result of performing measurements by gel permeation chromatography (GPC) to analyze the molecular weight of the synthesized isohexide-based organic-inorganic compound, it was confirmed that the compound had a number average molecular weight of about 1,250, a weight average molecular weight of about 6,470, and a polydispersity index (PDI) of about 5.2.

As a result of measuring the biocarbon content of the synthesized isohexide-based organic-inorganic compound according to the ASTM D 6866 standard, it was confirmed that the compound contained about 64.7% of biocarbon.

### Example 3

Triethoxy-[3-[(3-ethyloxetan-3-yl)methoxy]propyl] silane (BenchChem Company), tetraethyl orthosilicate (Sigma-Aldrich Company), isosorbide (Sigma-Aldrich Company), and Amberlite IRA-400 (Sigma-Aldrich Company) were introduced at a ratio of 11.4 g:2.5 g:27.8 g:2.5 g into a 2-neck flask with a capacity of 100 ml, and stirred at 80° C. for 24 hours to obtain an isohexide-based organic-inorganic compound having an average unit formula of Formula 10 below.

[Formula 10] Average unit formula of isohexide-based organic-inorganic compound of Example 3

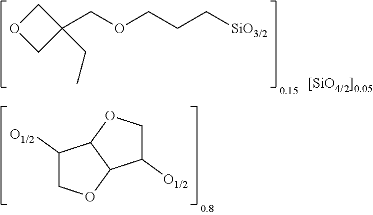

As a result of performing measurements by gel permeation chromatography (GPC) to analyze the molecular weight of the synthesized isohexide-based organic-inorganic compound, it was confirmed that the compound had a number average molecular weight of about 1,025, a weight average molecular weight of about 4,800, and a polydispersity index (PDI) of about 4.7.

As a result of measuring the biocarbon content of the synthesized isohexide-based organic-inorganic compound according to the ASTM D 6866 standard, it was confirmed that the compound contained about 74.8% of biocarbon.

### Example 4

2-(3,4-epoxycyclohexyl)ethyltrimethoxysilane (EC TMS, Sigma-Aldrich Company), isosorbide (Sigma-Aldrich Company), and Amberlite IRA-400 (Sigma-Aldrich Company) were introduced at a ratio of 6.5 g:34.6 g:2.5 g into a 2-neck flask with a capacity of 100 ml, and stirred at 80° C. for 24 hours to obtain an isohexide-based organic-inorganic compound having an average unit formula of Formula 11 below.

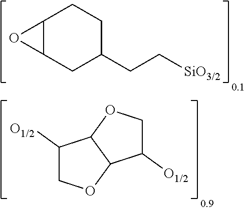

[Formula 11] Average unit formula of isohexide-based organic-inorganic compound of Example 4

As a result of performing measurements by gel permeation chromatography (GPC) to analyze the molecular weight of the synthesized isohexide-based organic-inorganic compound, it was confirmed that the compound had a number average molecular weight of about 980, a weight average molecular weight of about 2,890, and a polydispersity index (PDI) of about 2.9.

As a result of measuring the biocarbon content of the synthesized isohexide-based organic-inorganic compound according to the ASTM D 6866 standard, it was confirmed that the compound contained about 82.6% of biocarbon.

### Example 5

3-glycidoxypropyltrimethoxysilane (Gelest Company), (3-glycidoxypropyl)dimethylethoxysilane (Gelest Company), isosorbide (Sigma-Aldrich Company), and Amberlite IRA-400 (Sigma-Aldrich Company) were introduced at a ratio of 42.2 g:7.8 g:20.9 g:3.7 g into a 2-neck flask with a capacity of 200 ml, and stirred at 80° C. for 24 hours. Thereafter, about 1.0 g of DI water was introduced thereto, and the mixture was stirred at 80° C. for 24 hours to obtain an isohexide-based organic-inorganic compound having an average unit formula of Formula 12 below.

[Formula 12] Average unit formula of isohexide-based organic-inorganic compound of Example 5

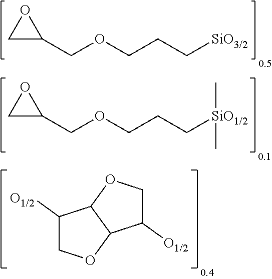

As a result of performing measurements by gel permeation chromatography (GPC) to analyze the molecular weight of the synthesized isohexide-based organic-inorganic compound, it was confirmed that the compound had a number average molecular weight of about 4,850, a weight average molecular weight of about 14,500, and a polydispersity index (PDI) of about 3.0.

As a result of measuring the biocarbon content of the synthesized isohexide-based organic-inorganic compound according to the ASTM D 6866 standard, it was confirmed that the compound contained about 35.6% of biocarbon.

### Example 6

(3-glycidoxypropyl)dimethoxymethylsilane (Sigma-Aldrich Company), tetraethyl orthosilicate (Sigma-Aldrich Company), isosorbide (Sigma-Aldrich Company), and Amberlite IRA-400 (Sigma-Aldrich Company) were introduced at a ratio of 27.5 g:5.2 g:14.6 g:3.5 g into a 2-neck flask with a capacity of 100 ml, and stirred at 80° C. for 24 hours to obtain an isohexide-based organic-inorganic compound having an average unit formula of Formula 13 below.

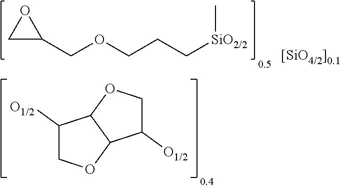

[Formula 13] Average unit formula of isohexide-based organic-inorganic compound of Example 6

As a result of performing measurements by gel permeation chromatography (GPC) to analyze the molecular weight of the synthesized isohexide-based organic-inorganic compound, it was confirmed that the compound had a number average molecular weight of about 3,420, a weight average molecular weight of about 11,800, and a polydispersity index (PDI) of about 3.5.

As a result of measuring the biocarbon content of the synthesized isohexide-based organic-inorganic compound according to the ASTM D 6866 standard, it was confirmed that the compound contained about 39.7% of biocarbon.

### Example 7

3-aminopropyltrimethoxy silane (Sigma-Aldrich Company), isosorbide (Sigma-Aldrich Company), and Amberlite IRA-400 (Sigma-Aldrich Company) were introduced at a ratio of 46.3 g:9.4 g:2.8 g into a 2-neck flask with a capacity of 100 ml, and stirred at 80° C. for 24 hours. Thereafter, about 1.0 g of DI water and 0.1 g of potassium hydroxide (Sigma-Aldrich Company) were introduced thereto, and the mixture was stirred at 80° C. for 24 hours to obtain an isohexide-based organic-inorganic compound having an average unit formula of Formula 14 below.

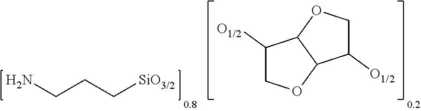

[Formula 14] Average unit formula of isohexide-based organic-inorganic compound of Example 7

As a result of performing measurements by gel permeation chromatography (GPC) to analyze the molecular weight of the synthesized isohexide-based organic-inorganic compound, it was confirmed that the compound had a number average molecular weight of about 3,850, a weight average molecular weight of about 12,500, and a polydispersity index (PDI) of about 3.2.

As a result of measuring the biocarbon content of the synthesized isohexide-based organic-inorganic compound according to the ASTM D 6866 standard, it was confirmed that the compound contained about 32.1% of biocarbon.

### Example 8

3-aminopropyltrimethoxy silane (Sigma-Aldrich Company), dimethoxydiphenylsilane (Sigma-Aldrich Company), isosorbide (Sigma-Aldrich Company), and Amberlite IRA-400 (Sigma-Aldrich Company) were introduced at a ratio of 25.6 g:17.5 g:20.9 g:3.8 g into a 2-neck flask with a capacity of 200 ml, and stirred at 80° C. for 24 hours to obtain an isohexide-based organic-inorganic compound having an average unit formula of Formula 15 below.

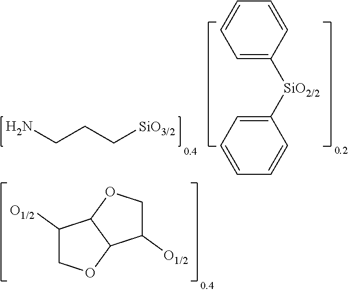

[Formula 15] Average unit formula of isohexide-based organic-inorganic compound of Example 8

As a result of performing measurements by gel permeation chromatography (GPC) to analyze the molecular weight of the synthesized isohexide-based organic-inorganic compound, it was confirmed that the compound had a number average molecular weight of about 2,450, a weight average molecular weight of about 9,810, and a polydispersity index (PDI) of about 4.0.

As a result of measuring the biocarbon content of the synthesized isohexide-based organic-inorganic compound according to the ASTM D 6866 standard, it was confirmed that the compound contained about 38.9% of biocarbon.

### Example 9

3-glycidoxypropyltrimethoxysilane (Gelest Company), (3-glycidoxypropyl)dimethoxymethylsilane (Sigma-Aldrich Company), tetraethyl orthosilicate (Sigma-Aldrich Company), isosorbide (Sigma-Aldrich Company), and Amberlite IRA-400 (Sigma-Aldrich Company) were introduced at a ratio of 20.3 g:6.3 g:17.9 g:12.5 g into a 2-neck flask with a capacity of 200 ml, and stirred at 80° C. for 24 hours. Thereafter, about 0.8 g of 0.1 N dilute hydrochloric acid (Sigma-Aldrich Company) was introduced thereto, and the mixture was stirred at 80° C. for 24 hours to obtain an isohexide-based organic-inorganic compound having an average unit formula of Formula 16 below.

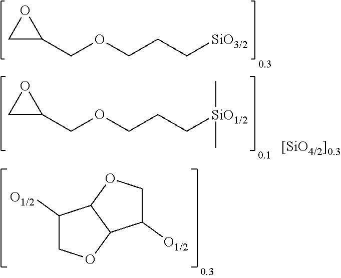

[Formula 16] Average unit formula of isohexide-based organic-inorganic compound of Example 9

As a result of performing measurements by gel permeation chromatography (GPC) to analyze the molecular weight of the synthesized isohexide-based organic-inorganic compound, it was confirmed that the compound had a number average molecular weight of about 4,570, a weight average molecular weight of about 14,250, and a polydispersity index (PDI) of about 3.1.

As a result of measuring the biocarbon content of the synthesized isohexide-based organic-inorganic compound according to the ASTM D 6866 standard, it was confirmed that the compound contained about 39.5% of biocarbon.

### Example 10

2-(3,4-epoxycyclohexyl)ethyltrimethoxysilane (ECTMS, Sigma-Aldrich Company), dimethoxydimethylsilane (Sigma-Aldrich Company), isosorbide (Sigma-Aldrich Company), and Amberlite IRA-400 (Sigma-Aldrich Company) were introduced at a ratio of 13.0 g:19.0 g:7.7 g:2.8 g into a 2-neck flask with a capacity of 100 ml, and stirred at 80° C. for 24 hours. Thereafter, about 2.8 g of DI water and 0.1 g of potassium hydroxide (Sigma-Aldrich Company) were introduced thereto, and the mixture was stirred at 80° C. for 24 hours to obtain an isohexide-based organic-inorganic compound having an average unit formula of Formula 17 below.

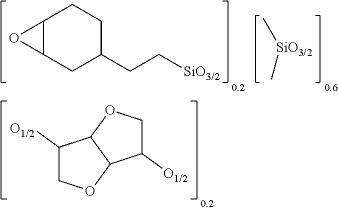

[Formula 17] Average unit formula of isohexide-based organic-inorganic compound of Example 10

As a result of performing measurements by gel permeation chromatography (GPC) to analyze the molecular weight of the synthesized isohexide-based organic-inorganic compound, it was confirmed that the compound had a number average molecular weight of about 2,840, a weight average molecular weight of about 10,380, and a polydispersity index (PDI) of about 3.7.

As a result of measuring the biocarbon content of the synthesized isohexide-based organic-inorganic compound according to the ASTM D 6866 standard, it was confirmed that the compound contained about 28.5% of biocarbon.

### Example 11

3-(trimethoxysilyl)propyl methacrylate (Sigma-Aldrich Company), dimethoxydimethylsilane (Sigma-Aldrich Company), tetraethyl orthosilicate (Sigma-Aldrich Company), isosorbide (Sigma-Aldrich Company), and Amberlite IRA-400 (Sigma-Aldrich Company) were introduced at a ratio of 5.9 g:17.2 g:9.9 g:3.5 g:1.8 g into a 2-neck flask with a capacity of 100 ml, and stirred at 80° C. for 24 hours. Thereafter, about 3.4 g of 0.1 N dilute hydrochloric acid (Sigma-Aldrich Company) was introduced thereto, and the mixture was stirred at 80° C. for 24 hours to obtain an isohexide-based organic-inorganic compound having an average unit formula of Formula 18 below.

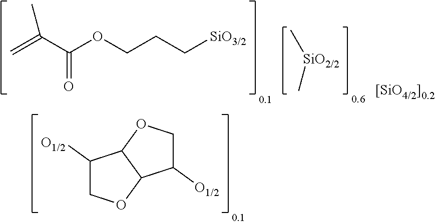

[Formula 18] Average unit formula of isohexide-based organic-inorganic compound of Example 11

As a result of performing measurements by gel permeation chromatography (GPC) to analyze the molecular weight of the synthesized isohexide-based organic-inorganic compound, it was confirmed that the compound had a number average molecular weight of about 3,580, a weight average molecular weight of about 9,840, and a polydispersity index (PDI) of about 2.7.

As a result of measuring the biocarbon content of the synthesized isohexide-based organic-inorganic compound according to the ASTM D 6866 standard, it was confirmed that the compound contained about 22.5% of biocarbon.

### Example 12

Vinyltrimethoxysilane (Sigma-Aldrich Company), dimethoxydimethylsilane (Sigma-Aldrich Company), isosorbide (Sigma-Aldrich Company), and Amberlite IRA-400 (Sigma-Aldrich Company) were introduced at a ratio of 9.4 g:26.7 g:4.6 g:1.5 g into a 2-neck flask with a capacity of 100 ml, and stirred at 80° C. for 24 hours. Thereafter, about 5.1 g of 0.05 N dilute hydrochloric acid (Sigma-Aldrich Company) was introduced thereto, and the mixture was stirred at 80° C. for 24 hours to obtain an isohexide-based organic-inorganic compound having an average unit formula of Formula 19 below.

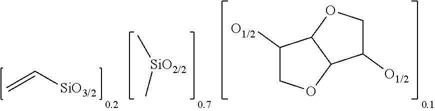

[Formula 19] Average unit formula of isohexide-based organic-inorganic compound of Example 12

As a result of performing measurements by gel permeation chromatography (GPC) to analyze the molecular weight of the synthesized isohexide-based organic-inorganic compound, it was confirmed that the compound had a number average molecular weight of about 2,560, a weight average molecular weight of about 7,520, and a polydispersity index (PDI) of about 2.9.

As a result of measuring the biocarbon content of the synthesized isohexide-based organic-inorganic compound according to the ASTM D 6866 standard, it was confirmed that the compound contained about 22.9% of biocarbon.

### Example 13

(3-mercaptopropyl)trimethoxysilane (Sigma-Aldrich Company), tetraethyl orthosilicate (Sigma-Aldrich Company), isosorbide (Sigma-Aldrich Company), and Amberlite IRA-400 (Sigma-Aldrich Company) were introduced at a ratio of 24.2 g:6.4 g:22.5 g:3.1 g into a 2-neck flask with a capacity of 100 ml, and stirred at 80° C. for 24 hours to obtain an isohexide-based organic-inorganic compound having an average unit formula of Formula 20 below.

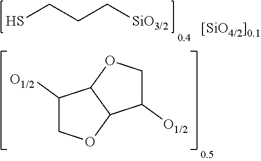

[Formula 20] Average unit formula of isohexide-based organic-inorganic compound of Example 13

As a result of performing measurements by gel permeation chromatography (GPC) to analyze the molecular weight of the synthesized isohexide-based organic-inorganic compound, it was confirmed that the compound had a number average molecular weight of about 2,150, a weight average molecular weight of about 11,900, and a polydispersity index (PDI) of about 5.5.

As a result of measuring the biocarbon content of the synthesized isohexide-based organic-inorganic compound according to the ASTM D 6866 standard, it was confirmed that the compound contained about 70.2% of biocarbon.

### Example 14

3-(triethoxy silyl)propyl isocyanate (Sigma-Aldrich Company), dimethoxydiphenylsilane (Sigma-Aldrich Company), isosorbide (Sigma-Aldrich Company), and Amberlite IRA-400 (Sigma-Aldrich Company) were introduced at a ratio of 23.6 g:11.6 g:13.9 g:2.1 g into a 2-neck flask with a capacity of 100 ml, and stirred at 80° C. for 24 hours. Thereafter, about 0.4 g of 0.1 N dilute hydrochloric acid (Sigma-Aldrich Company) was introduced thereto to obtain an isohexide-based organic-inorganic compound having an average unit formula of Formula 21 below.

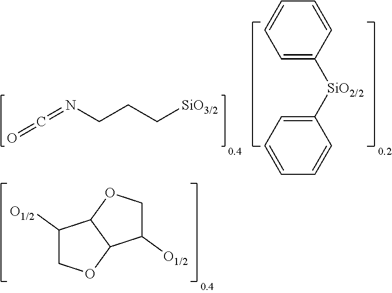

[Formula 21] Average unit formula of isohexide-based organic-inorganic compound of Example 14

As a result of performing measurements by gel permeation chromatography (GPC) to analyze the molecular weight of the synthesized isohexide-based organic-inorganic compound, it was confirmed that the compound had a number average molecular weight of about 3,820, a weight average molecular weight of about 7,890, and a polydispersity index (PDI) of about 2.1.

As a result of measuring the biocarbon content of the synthesized isohexide-based organic-inorganic compound according to the ASTM D 6866 standard, it was confirmed that the compound contained about 35.4% of biocarbon.

### Comparative Example 1

2-(3,4-epoxycyclohexyl)ethyltrimethoxysilane (ECTMS, Sigma-Aldrich Company), isosorbide (Sigma-Aldrich Company), and Amberlite IRA-400 (Sigma-Aldrich Company) were introduced at a ratio of 3.5 g:39.7 g:0.5 g into a 2-neck flask with a capacity of 100 ml, and stirred at 80° C. for 24 hours to obtain a synthesized product, but it was confirmed that the product was not uniform and phase separation occurred.

### Comparative Example 2

Vinyltrimethoxysilane (Sigma-Aldrich Company), dimethoxydimethylsilane (Sigma-Aldrich Company), isosorbide (Sigma-Aldrich Company), and Amberlite IRA-400 (Sigma-Aldrich Company) were introduced at a ratio of 10.6 g:32.2 g:2.6 g:1.1 g into a 2-neck flask with a capacity of 100 ml, and stirred at 80° C. for 24 hours. Thereafter, about 5.8 g of 0.05 N dilute hydrochloric acid (Sigma-Aldrich Company) was introduced thereto, and the mixture was stirred at 80° C. for 24 hours to obtain a compound having an average unit formula of Formula 22 below.

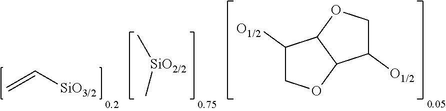

[Formula 22] Average unit formula of compound of Comparative Example 2

As a result of performing measurements by gel permeation chromatography (GPC) to analyze the molecular weight of the compound, it was confirmed that the compound had a number average molecular weight of about 2,840, a weight average molecular weight of about 8,510, and a polydispersity index (PDI) of about 3.0.

As a result of measuring the biocarbon content of the compound according to the ASTM D 6866 standard, it was confirmed that the compound contained about 11.5% of biocarbon.

### Comparative Example 3

3-glycidoxypropyltrimethoxysilane (Gelest Company), (3-glycidoxypropyl)dimethoxymethylsilane (Sigma-Aldrich Company), tetraethyl orthosilicate (Sigma-Aldrich Company), isosorbide (Sigma-Aldrich Company), and Amberlite IRA-400 (Sigma-Aldrich Company) were introduced at a ratio of 22.9 g:7.1 g:23.5 g:11.8 g into a 2-neck flask with a capacity of 200 ml, and stirred at 80° C. for 24 hours. Thereafter, about 0.6 g of 0.1 N dilute hydrochloric acid (Sigma-Aldrich Company) was introduced thereto, and the mixture was stirred at 80° C. for 24 hours to obtain a compound, but it was confirmed that gelation occurred.

Examples 1 to 14 and Comparative Examples 1 to 3 specify synthesized products respectively obtained by reacting a combination of silane compounds corresponding to Formulas 4, 5, 6, and 7 with isohexide, and the molar ratios of each reactant with respect to the total reactants are summarized as shown in Table 1 below.

TABLE 1

| | Formula 4 | Formula 5 | Formula 6 | Formula 7 | Isohexide |
|---|---|---|---|---|---|
| Example 1 | 0.4 | | | | 0.6 |
| Example 2 | 0.25 | | 0.05 | | 0.7 |
| Example 3 | 0.15 | | | 0.05 | 0.8 |
| Example 4 | 0.1 | | | | 0.9 |
| Example 5 | 0.5 | | 0.1 | | 0.4 |
| Example 6 | | 0.5 | | 0.1 | 0.4 |
| Example 7 | 0.8 | | | | 0.2 |
| Example 8 | 0.4 | 0.2 | | | 0.4 |
| Example 9 | 0.3 | | 0.1 | 0.3 | 0.3 |
| Example 10 | 0.2 | 0.6 | | | 0.2 |
| Example 11 | 0.1 | 0.6 | 0.2 | | 0.1 |
| Example 12 | 0.2 | 0.7 | | | 0.1 |
| Example 13 | 0.4 | | | 0.1 | 0.5 |
| Example 14 | 0.4 | 0.2 | | | 0.4 |
| Comparative | 0.05 | | | | 0.95 |
| Example 1 | | | | | |
| Comparative | 0.2 | 0.75 | | | 0.05 |
| Example 2 | | | | | |
| Comparative | 0.3 | 0.1 | | 0.35 | 0.25 |
| Example 3 | | | | | |

At this time, when the molar ratio of the silane compounds of Formulas 4, 5, and 6 above to the total reactants is defined as f, the molar ratio of the silane compound of Formula 7 above to the total reactants is defined as g, and the molar ratio of the isohexide to the total reactants is defined as h, Examples 1 to 14 satisfied 0.1≤f≤0.9, 0≤g≤0.3, and 0.1≤h≤0.9, and at the same time, the synthesis was well achieved, and the biocarbon content satisfied 20% or more, so that it was confirmed that it is possible to cope with eco-friendly policies related to bio-based plastics. However, in the case of Comparative Example 1 in which f<0.1 and h>0.9, there were relatively few silane compounds capable of forming a silyl ether bond with isohexide, so that it was confirmed that the synthesis was not properly achieved and phase separation occurred. In addition, in the case of Comparative Example 2 in which f>0.9 and h<0.1, the biocarbon content was about 11.5%, which was less than 20%, so that it was confirmed that it was insufficient for the bio-based plastic standards. Also, in the case of Comparative Example 3 in which g>0.3, it was confirmed that gelation occurred as the condensation reaction proceeded excessively.

An isohexide-based compound having a silyl ether bond according to the present invention has the silyl ether bond, and thus, may provide a low-carbon eco-friendly bioplastic solution as well as improve heat resistance and thermal mechanical properties. Accordingly, it may be possible to implement excellent heat resistance and thermal mechanical properties compared to those of a typical petrochemical-based epoxy.

Ultimately, the isohexide-based compound having a silyl ether bond of the inventive concept may be applied in the field of high-tech materials such as displays, semiconductors, automobiles, aviation, robots, and the like.

Although the present invention has been described with reference to the accompanying drawings, it will be understood by those having ordinary skill in the art to which the present invention pertains that various changes in form and details may be made therein without departing from the spirit and scope of the present invention. Therefore, it is to be understood that the above-described embodiments are exemplary and non-limiting in every respect.

What is claimed is:

1. An organic-inorganic compound comprising:
a first structural body; and
a curable reactive group,
wherein the first structural body has a structure in which silane and isohexide are chemically bonded through a silyl ether bond.

2. The organic-inorganic compound of claim 1, wherein the organic-inorganic compound satisfies Formula 1 below: 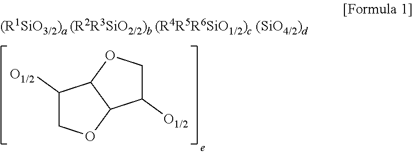
wherein in the above formula, a, b, and c are 0 or positive numbers, and d and e are positive numbers,
R¹, R², R³, R⁴, R⁵, and R⁶ above are each independently selected from the group consisting of a curable reactive group, a C₁ to C₂₀ alkyl group, a C₃ to C₈ cycloalkyl group, or a C₆ to C₂₀ aryl group, and
at least one of R¹, R², R³, R⁴, R⁵, or R⁶ above includes a curable reactive group.

3. The organic-inorganic compound of claim 1, further comprising a siloxane group bonded to the silyl ether group.

4. The organic-inorganic compound of claim 1, wherein:
0.1≤a+b+c≤0.9;
0≤d≤0.3;
0≤e≤0.9; and
a+b+c+d+e=1.

5. The organic-inorganic compound of claim 1, wherein the curable reactive group is selected from the group consisting of an epoxy group, an amine group, an acryl group, a methacrylic group, a mercapto group, a carboxyl group, a vinyl group, a nitro group, a sulfone group, a hydroxyl group, a urethane group, ureide, isocyanate, an oxetane group, or combinations thereof.

6. The organic-inorganic compound of claim 1, wherein the isohexide comprises at least one of isosorbide, isomanide, isoidide, or a combination thereof.

7. The organic-inorganic compound of claim 1, wherein the organic-inorganic compound satisfies Formula 2 below: 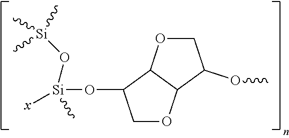
wherein in Formula 2 above, x includes the curable reactive group and a carbon compound, and
n is a positive number.

8. A method for producing an organic-inorganic compound, the method comprising:
preparing a silane compound;
preparing isohexide; and
reacting the silane compound with the isohexide,
wherein a silyl ether bond is formed by reacting the silane compound with the isohexide.

9. The method of claim 8, wherein the silane compound is selected from the group consisting of Formulas 4 to 7 below, or combinations thereof:
R¹Si(OR^{I})₃ [Formula 4]
R²R³Si(OR^{II})₂ [Formula 5]
R⁴R⁵R⁶Si(OR^{III}) [Formula 6]
Si(OR^{IV})₄ [Formula 7]
wherein R¹, R², R³, R⁴, R⁵, and R⁶ above are each independently selected from the group consisting of a curable reactive group, a C₁ to C₂₀ alkyl group, a C₃ to C₈ cycloalkyl group, or a C₆ to C₂₀ aryl group,
at least one of R¹, R², R³, R⁴, R⁵, or R⁶ above includes a curable reactive group, and
R^{I}, R^{II}, R^{III}, and RN above are each independently include hydrogen, a linear C₁ to C₆ alkyl group, and a branched C₁ to C₆ alkyl group.

10. The method of claim 9, wherein:
the molar ratio of the silane compounds of Formulas 4, 5, and 6 above to the total reactants is defined as f;
the molar ratio of the silane compound of Formula 7 above to the total reactants is defined as g, and
the molar ratio of the isohexide to the total reactants is defined as h, wherein 0≤f≤0.9, 0≤g≤0.3, 0.1≤h≤0.9, and f+g+h=1.

11. The method of claim 8, further comprising forming a siloxane bond.

12. The method of claim 11, wherein the forming of the siloxane bond comprises performing one or more reactions of a hydrolysis reaction or a condensation reaction between the silane compounds.

13. The method of claim 11, further comprising:
reacting the silane compound with the isohexide; and
using a catalyst to promote the forming of the siloxane bond, wherein the catalyst is one of the group consisting of:
an acidic catalyst such as acetic acid, hydrochloric acid, hydrogen fluoride, sulfuric acid, nitric acid, chlorosulfonic acid, iodic acid, and pyrophosphoric acid;
a basic catalyst such as potassium hydroxide, sodium hydroxide, barium hydroxide, and imidazole; and
an ion exchange resin, water, and combinations thereof.

14. The method of claim 9, wherein the curable reactive group included in the silane compound is an epoxy group and/or an oxetane group.

15. The method of claim 14, wherein the silane compound is any one of 5,6-epoxyhexyltriethoxysilane, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, 3-Ethyl-3-[[3-(triethoxysilyl)propoxy]methyl]oxetane, 7-trimethoxysilyl-4-thia-heptanoic acid-(3-ethyl-oxetan-3-yl)methyl ester, N-(3-triethoxysilylpropyl)-(3-ethyloxetan-3-yl)-methyl carbamate, 2-(3-triethoxysilylpropylthio)succinic acid-bis-[(3-ethyloxetane-3-yl)-methyl]ester, (3,4-epoxycyclohexyl)ethyldimethoxysilane, 2-(3,4-epoxycyclohexyl)ethyl(methyl)dimethoxysilane, (3,4-epoxycyclohexyl)ethyldiethoxysilane, 2-(3,4-epoxycyclohexyl)ethyl(methyl)diethoxysilane, (2-(7-oxabicyclo[4.1.0]heptan-3-yl)ethyl)(methyl)silanediol, dimethoxy(methyl)(3-(oxiran-2-yl)propyl)silane, diethoxy(methyl)(3-(oxiran-2-yl)propyl)silane, methyl(3-(oxiran-2-yl)propyl)silanediol, (3-glycidoxypropyl)dimethoxymethylsilane, (3-glycidoxypropyl)diethoxymethylsilane, and (3-glycidoxypropyl)methylsilanediol, (3-glycidoxypropyl)dimethylethoxysilane, and 3-glycidoxypropyldimethylmethoxysilane.

16. The method of claim 8, wherein the curable reactive group included in the silane compound comprises one or more among an amine group, a ureide group, an isocyanate group, and a mercapto group.

17. The method of claim 14, wherein the silane compound is any one of 4-aminobutyltriethoxysilane, 4-amino-3,3-dimethylbutyltrimethoxysilane, N-2-(Aminoethyl)-3-aminopropyltrimethoxysilane, N-(6-aminohexyl)aminomethyltriethoxysilane, N-(6-aminohexyl)aminopropyltrimethoxysilane, n-(2-aminoethyl)-11-aminoundecyltrimethoxysilane, N-(2-aminoethyl)-3-aminopropylsilanetriol, 3-Aminopropyltrimethoxysilane, 3-Aminopropyltriethoxysilane, 3-Triethoxysilyl-N-(1,3 dimethyl-butylidene) propylamine, N-Phenyl-3-aminopropyltrimethoxysilane, N-(Vinylbenzyl)-2-aminoethyl3-aminopropyltrimethoxysilane hydrochloride, 3-(m-aminophenoxy)propyltrimethoxysilane, m-aminophenyltrimethoxysilane, p-aminophenyltrimethoxysilane, aminophenyltrimethoxysilane, 3-aminopropyltris(methoxyethoxyethoxy)silane, 11-aminoundecyltriethoxysilane, 2-(4-pyridylethyl)triethoxysilane, 2-(2-pyridylethyl)trimethoxysilane, N-(3-trimethoxysilylpropyl)pyrrole, 3-aminopropylsilanetriol, (aminoethylaminomethyl)phenethyltrimethoxysilane, 3-ureidopropyltrialkoxysilane, 3-isocyanatepropyltriethoxysilane, 3-mercaptopropyltrimethoxysilane, N-2-(Aminoethyl)-3-aminopropylmethyldimethoxysilane, N-(2-aminoethyl)-3-aminopropylmethyldiethoxysilane, N-(2-aminoethyl)-3-aminoisobutylmethyldimethoxysilane, 4-amino-3,3-dimethylbutylmethyldimethoxysilane, 3-aminopropylmethyldiethoxysilane, 3-Mercaptopropylmethyldimethoxysilane, 1-amino-2-(dimethylethoxysilyl)propane, 3-aminopropyldiisopropylethoxysilane, 3-aminopropyldimethylethoxysilane, and N-(2-aminoethyl)-3-aminoisobutyldimethylmethoxysilane.

18. A curable composition comprising:
an organic-inorganic compound including a first structural body and a curable reactive group; and
a curing agent,
wherein:
the first structural body has a structure in which silane and isohexide are chemically bonded through a silyl ether bond; and
the curable reactive group is any one of an epoxy group, an oxetane group, or a combination thereof.

19. The curable composition of claim 18, further comprising:
an initiator;
a reactive diluent; and
an additive,
wherein:
the curing agent is any one of a silyl ether isohexide-based organic-inorganic compound having an amine group, a ureide group, an isocyanate group, or a mercapto group as a curing reactive group, an acid-based curing agent, an amine-based curing agent, an imidazole-based curing agent, a carboxylic acid-based curing agent, a phosphine-based curing agent, a urea derivative-based curing agent, and a combination thereof;
the initiator is any one of a photoacid generator, a photobase generator, a thermal acid generator, and a combination thereof;
the reactive diluent is any one of an epoxy reactive diluent, an oxetane reactive diluent, polyethylene glycol, and a combination thereof; and
the additive is any one of graphene, carbon nanotube, fullerene, hexagonal boron nitride, boron nitride nanotube, alumina, MXene, and a combination thereof.

20. The organic-inorganic compound of claim 18, wherein the first structural body further comprises a siloxane bond.
